(19) United States
(12) Patent Application Publication
(10) Pub. No.: US 2014/0032087 A1
(43) Pub. Date: Jan. 30, 2014

(54) REDUCING FUEL CONSUMPTION BY ACCOMMODATING TO ANTICIPATED ROAD AND DRIVING CONDITIONS

(71) Applicants: Yossi SHIRI, Ashdod (IL); Alex ACKERMAN, Rishon Letzion (IL); Boaz MIZRACHI, Haifa (IL)

(72) Inventors: Yossi SHIRI, Ashdod (IL); Alex ACKERMAN, Rishon Letzion (IL); Boaz MIZRACHI, Haifa (IL)

(73) Assignee: MOBIWIZE SOLUTIONS LTD., Haifa (IL)

(21) Appl. No.: 13/557,344

(22) Filed: Jul. 25, 2012

(51) Int. Cl. G06F 17/00

(52) U.S. Cl. CPC G06F 17/00
USPC 701/117; 701/123; 701/533

(57) ABSTRACT

Utilizing a database of route segments, calculating optimal velocity and acceleration profiles, and suggesting these profiles to a user or the cruise control system of the vehicle, based on a route analysis and incorporating external and local data sources relating to environmental (e.g. topographic, meteorological) conditions, traffic conditions and user preferences and characteristics.

### BACKGROUND

1. Technical Field

The present invention generally relates to the field of transportation. More particularly, the present invention relates to a method of reducing fuel consumption.

2. Discussion Of Related Art

U.S. Pat. No. 5,742,922, which is incorporated herein by reference in its entirety, discloses a vehicle navigation system and method for selecting a route according to fuel consumption. U.S. Pat. No. 5,913,917, which is incorporated herein by reference in its entirety, discloses a method and apparatus for prediction or estimation of fuel or energy consumption by a vehicle over a chosen trip route, where the route includes a plurality of road segments.

### BRIEF SUMMARY

The present invention discloses a system and method for suggesting a driving behavior that reduces fuel consumption to a user with a communication device driving a vehicle along an estimated route. The method comprises the stages: (i) receiving data related to the vehicle, its position, the estimated route, environmental driving conditions along the estimated route and user preferences, (ii) segmenting the estimated route, (iii) calculating optimal velocities and accelerations for at least one relevant segment of the estimated route, (iv) receiving the vehicle's position and finding current segment during driving, (v) calculating and suggesting current optimal velocity and accelerations during driving using the calculated optimal velocities and accelerations for at least one relevant segment following current segment.

In embodiments, the environmental driving conditions along the estimated route may comprise topographical data, meteorological data, traffic conditions, or a combination thereof. In embodiments, the method further comprises feeding the driving behavior to the cruise control system of the vehicle. In embodiments, the method further comprises measuring vehicle position, vehicle velocity, vehicle acceleration, or a combination thereof.

The system implements the method utilizing a variety of external and local information sources, and relating to environmental (e.g. topographic, meteorological) conditions, traffic conditions and user preferences and characteristics.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

FIGS. 1A to 1E are block diagrams illustrating a data processing system for suggesting a driving behavior that reduces fuel consumption to a user with a communication device driving a vehicle along an estimated route, according to some embodiments of the invention,

FIG. 2 is a flowchart illustrating a method of suggesting a driving behavior that reduces fuel consumption to a user driving a vehicle along an estimated route, according to some embodiments of the invention,

FIGS. 3A and 3B are flowcharts illustrating a method of suggesting a driving behavior that reduces fuel consumption to a user driving a vehicle along an estimated route, according to some embodiments of the invention, and

FIG. 4 is a flowchart illustrating a method of reducing fuel consumption by accommodating to anticipated road and driving conditions, according to some embodiments of the invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention discloses a system and method for minimizing fuel consumption. The system and method utilize a database of route segments, for which they calculate optimal velocity and acceleration profiles, and suggests these profiles to a user, based on a route analysis and incorporating external and local data sources relating to environmental (e.g. topographic, meteorological) conditions, traffic conditions and user preferences and characteristics. Abbreviations used in the description include: GIS for geographic information system, GPS for global positioning system, CAN bus for controller area network bus allowing devices and controllers in a vehicle to communicate among themselves and with other devices. The system and method may further suggest optimal gear setting and gear changing times, and may incorporate the suggestions in the operation of an automatic gear system.

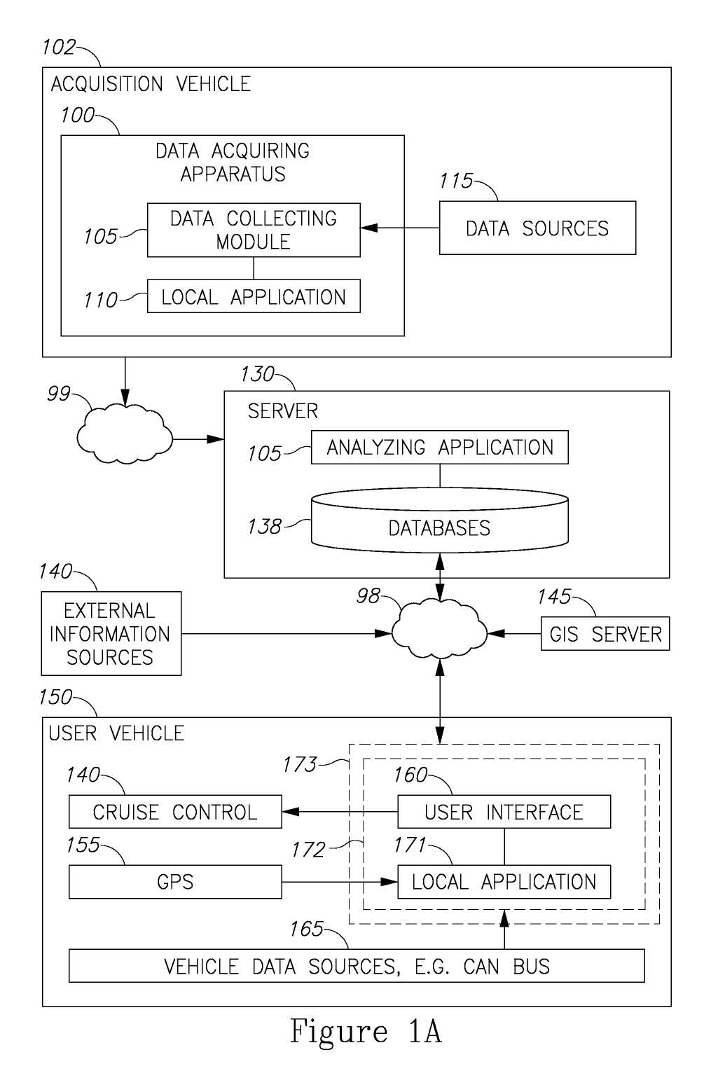

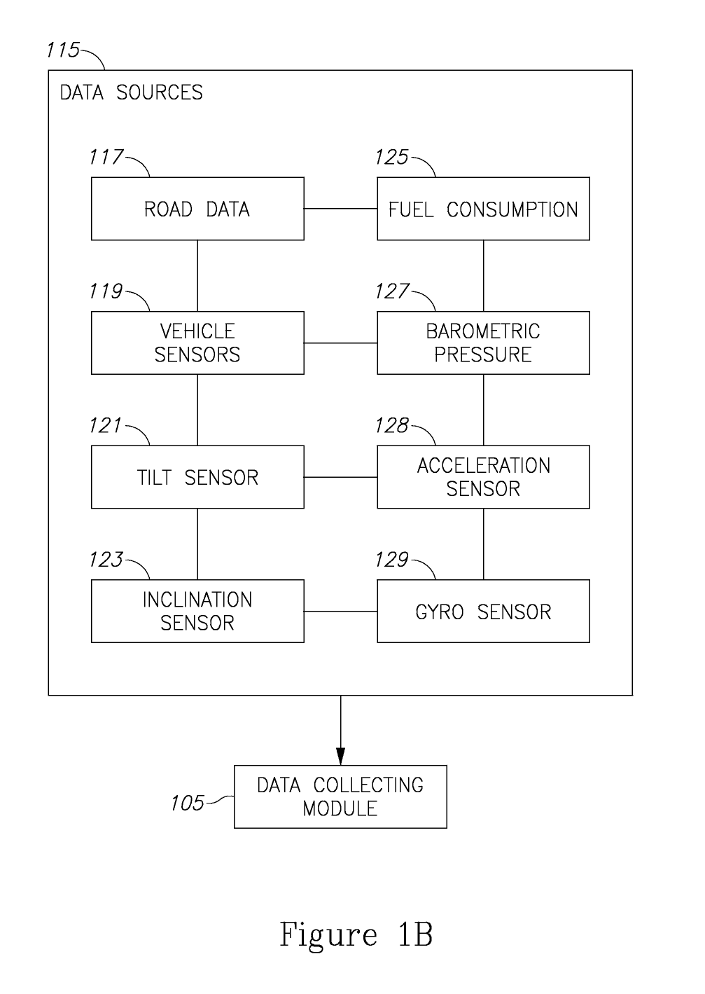

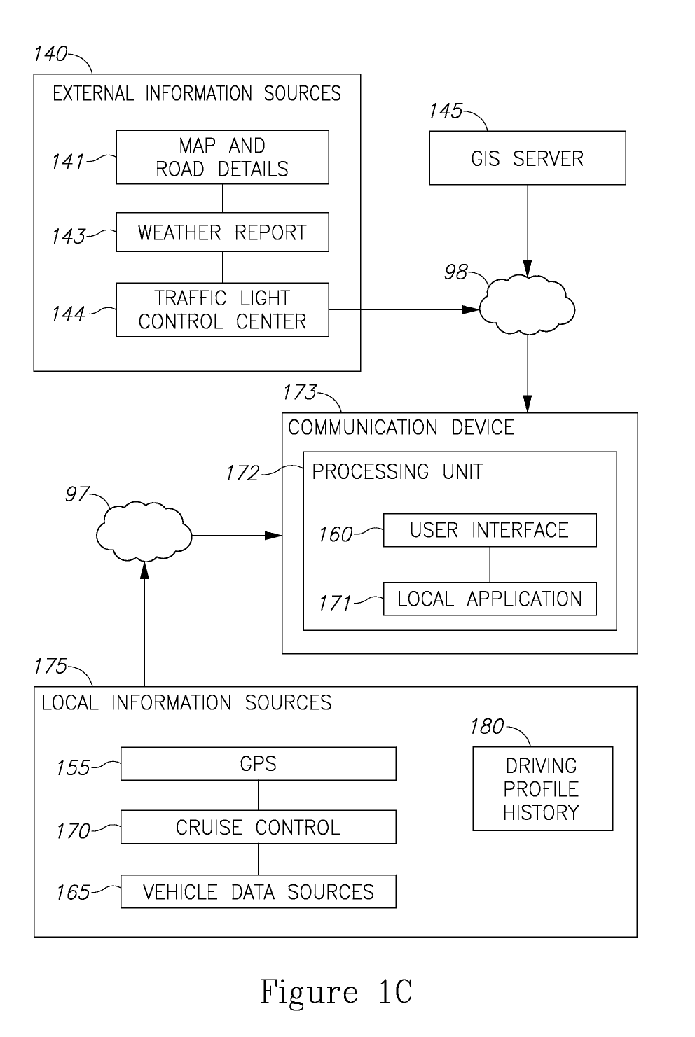

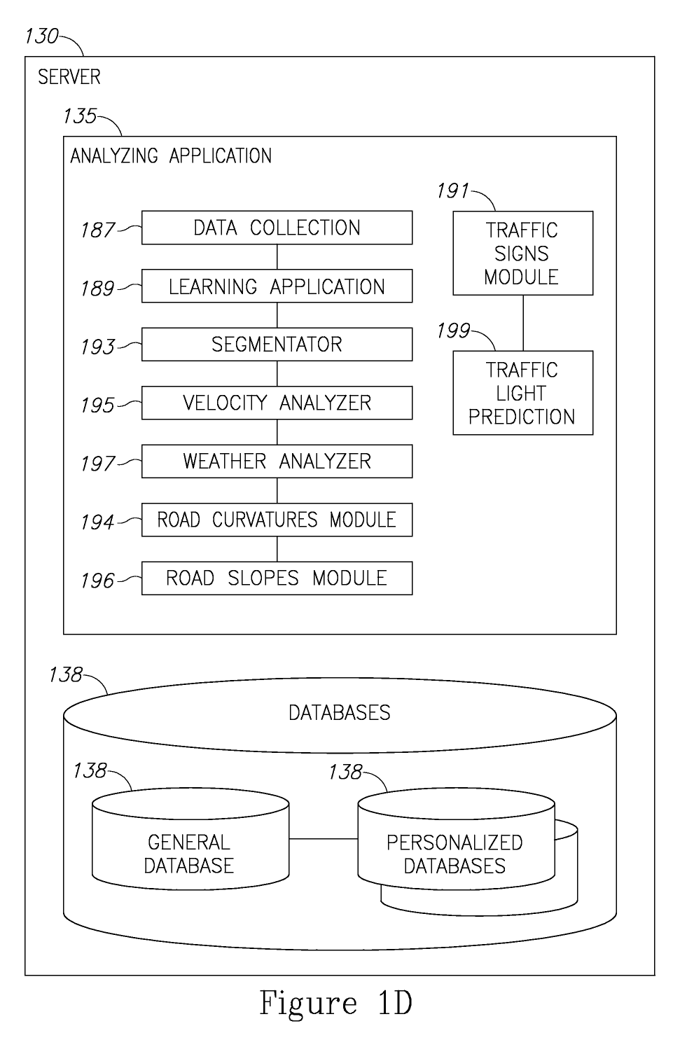

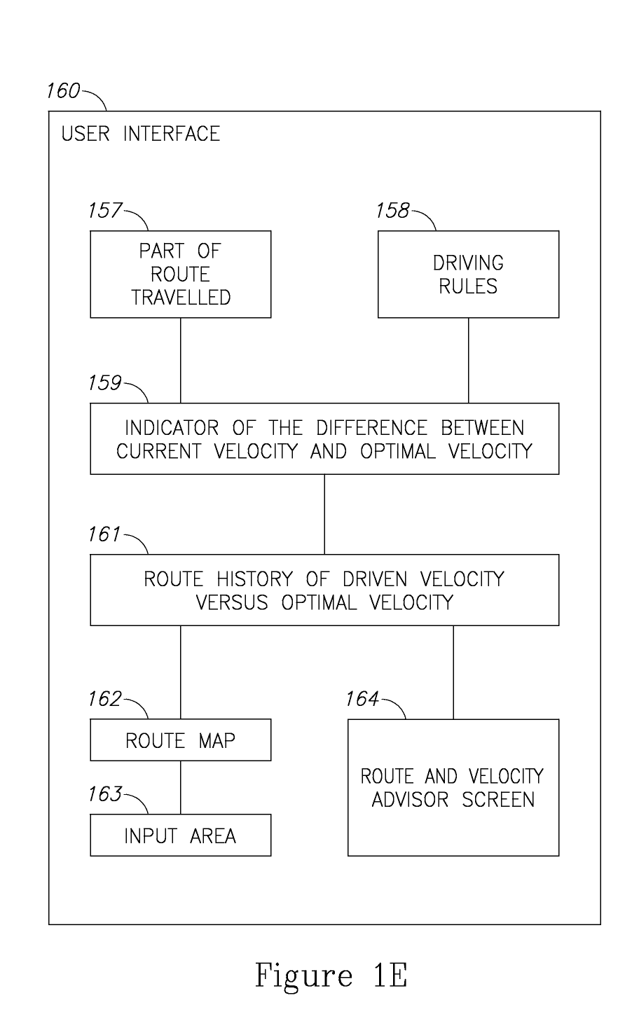

FIGS. 1A to 1E are block diagrams illustrating a data processing system for suggesting a driving behavior that reduces fuel consumption to a user with a communication device 173 driving a vehicle 150 along an estimated route, according to some embodiments of the invention. FIG. 1A is a general illustration of the system and FIGS. 1B-1E illustrate parts of the system in more detail. The estimated route may be automatically estimated or inputted by the user, is divided into segments, and in at least one relevant segment the optimal velocities and accelerations are calculated in respect of the prevailing environmental parameters, such that fuel consumption is minimized. The term “estimated route” denotes both estimated routes derived from manually entered destination, as well as one or more segments estimated automatically, e.g. to destinations for which the driver has more than one option of driving, or in cases in which no destination was entered and according to past experience or road limitations.

The data processing system comprises a server 130 connected via a first communication link 98 with communication device 173 that comprises a processing unit 172. Server 130 comprises databases 138 and an analyzing application 135 (further details in FIG. 1D). The data processing system further comprises processing unit 172, comprising a user interface 160 connected to a local application 171; processing unit 172 in the user's communication device is connected via first communication link 98 to server 130, as well as to external information sources 140 and a GIS server 145, and additionally to a GPS instrument 155 (e.g. integrated in communication device 173), vehicle data sources 165 (optional) and vehicle cruise control 170 (optional). User interface 160 is configured to receive suggestions from server 130 and display suggestions to the user. These suggestions may relate to optimal driving velocities that facilitate the reduction of fuel consumption. Further suggestions may include optimal gear and optimal gear shifting timing (in manual as well as automatic gear systems). Components of user interface 160 are illustrated in FIG. 1E and the information sources in FIG. 1C.

Embodiments of the invention may include implementing the algorithm in relation to a GPS device, without the user having a communication device, and without the realtime receiving and analyzing of vehicle data. Segmenting and suggesting optimal driving behavior may then be calculated according to the navigated route that is processed by the GPS device.

According to some embodiments of the invention, communication device 173 may comprise a mobile phone, a personal navigation device, a personal digital assistant or different electronical appliance. Processing unit 172 may be installed or embedded in communication device 173. According to some embodiments of the invention, communication device 173 may operate offline and comprise any device comprising processing unit 172.

According to some embodiments of the invention, at least some of the functions and modules of server 130 are embedded in user's communication device 173, e.g. in processing unit 172 such as in local application 171 connected to user interface 160. Suggestions relating to optimal driving velocities that facilitate the reduction of fuel consumption may be generated locally by processing unit 172. The data processing system may further comprise several data acquiring apparatuses 100 installed in different vehicles 102 and connected via a second communication link 99 to server 130. Data acquiring apparatus 100 comprises a data collecting module 105 for acquiring data from some of different data sources 115 in acquisition vehicles 102 (see FIG. 1B for details) and a local application 110 for analyzing the data and sending the analyzed data to server 130 via second communication link 99. The data is then further analyzed by analyzing application 135 and stored in databases 138 (e.g. in general database 137). According to some embodiments of the invention, data may be analyzed locally on acquisition vehicle 102 by local application 110.

The acquisition of data is utilized to collect fuel consumption data for different route segments at different prevailing environmental parameters and adjust the modules and parameters for the models used to relate these data to fuel consumption. For example, the system may begin with a basic model and adjust its parameters and add modules to it as the database from the data collecting modules 105 installed on different acquisition vehicles 102 accumulates. The analysis of the data may be partly or fully performed on data acquisition apparatus 105 itself, using a local application 110, to reduce needed bandwidth from transferring the data via second communication link 99.

FIG. 1B is a block diagram illustrating data sources 115 in acquisition vehicles 102, according to some embodiments of the invention. Data sources 115 may comprise fuel consumption data 125, road data 117, data from acquisition vehicle's 102 sensors 119, from a tilt sensor 121, and inclination sensor 123, a barometric pressure sensor 127, an acceleration sensor 128, a gyro sensor 129, etc.

FIG. 1C is a block diagram illustrating the information sources that flow into processing unit 172 comprising user interface 160, and local application 171, according to some embodiments of the invention. External information sources 140 and a GIS server 145 supply data to user interface 160 via the first communication link 98. External information sources 140 may comprise map and road details 141, weather report data 143 (e.g. temperature, wind, pressure etc.) and traffic light control center 144. Map and road details 141 may comprise at least some of the following: Topographical data relating to different segments in the road (e.g. elevation, slopes, curvatures), road data such as number of lanes, speed limits etc., data related to crossroads, lengths of road segments, traffic signs and regulations related to the road, addresses of buildings, facilities and institutes along the road and so forth. In addition, map and road details 141 may comprise actual information such as road works, traffic hotspots, accident reports, speed traps etc.

Local information sources 175, i.e. information sources related to the user and the vehicle, provide data to user interface 160 via a third communication link 97. Local information sources 175 are those available in user's vehicle 150 and in communication device 173, such as a GPS receiver 155, a cruise control system 170, vehicle data sources 165 such as different sensors and the CAN-bus and a database comprising driving profile history 180. This database 180 may be part of local information sources 175, or may be part of personalized databases 139 (FIG. 1D) on server 130.

FIG. 1D is a block diagram illustrating the server of the data processing system, according to some embodiments of the invention. Server 130 comprises databases 138 and an analyzing application 135. Databases 138 comprise a general database 137 with route segmenting data and personalized databases 139 with user related data. Analyzing application 135 is configured to analyze the estimated route according to data from general database 137, and for suggesting a driving behavior that reduces fuel consumption for driving the estimated route in relation to data from personalized databases 139. Analyzing application 135 comprises a learning application 189 for learning said user's driving behavior, a segmenting module 193 for segmenting the estimated route, a traffic sign module 191 for analyzing traffic signs along the estimated route, a velocity analyzer 195 for calculating and suggesting velocities and accelerations that reduces fuel consumption in relation with the estimated route, driving behavior, and traffic signs, a data collection module 187 relating to data acquiring apparatus 100, a traffic light prediction module 199 relating to traffic light control center 144 and a weather analyzing module 197 relating to the source of weather reports 143. Analyzing application 135 further comprises a road curvatures module 194 and a road slopes module 196.

According to some embodiments of the invention, at least some of the functions and modules of server 130 are embedded in user's communication device 173, or in local application 171 connected to user interface 160. Such functions and modules may comprise map and road details 141, analyzing application 135 or elements thereof (e.g. learning application 189 or segmenting module 193) and databases 138 or its elements such as general database 137.

The system may comprise a road database comprising road data 117, vehicle database 165 comprising vehicle data from a vehicle, processing unit 172 arranged to anticipate, calculate and segment a vehicle route according to driver indications, and to derive a continuous velocity profile along the route that minimizes fuel consumption with respect o the road data and the vehicle data, and user interface 160 arranged to suggest driver actions along the route according to the derived velocity profile and actual derivations of the vehicle therefrom. The system may further comprise server 130 having analyzing application 105 that is further arranged to calculate segment slopes in a given region from a cumulative database of vehicles moving in the given region.

FIG. 1E is a block diagram illustrating the display elements of user interface 160, according to some embodiments of the invention. User interface 160 may display an indicator of the difference between the current velocity and the optimal velocity 159 (based on optimization calculations), e.g. in the form of a needle indicator on a background comprising a red area (velocities corresponding to a high fuel consumption) and a green area (velocities corresponding to a low fuel consumption). User interface 160 may display the route history of the driven velocity versus the optimal velocity 161 and calculate the total deviation from an optimal velocity profile in terms of e.g. percent, fuel consumption or money. User interface 160 may further display data related to the travelled route, such as the part of the route travelled 157, route map 162, traffic signs and driving rules 158 along the route, as well as a route and velocity advisor screen 164 and an input area 163.

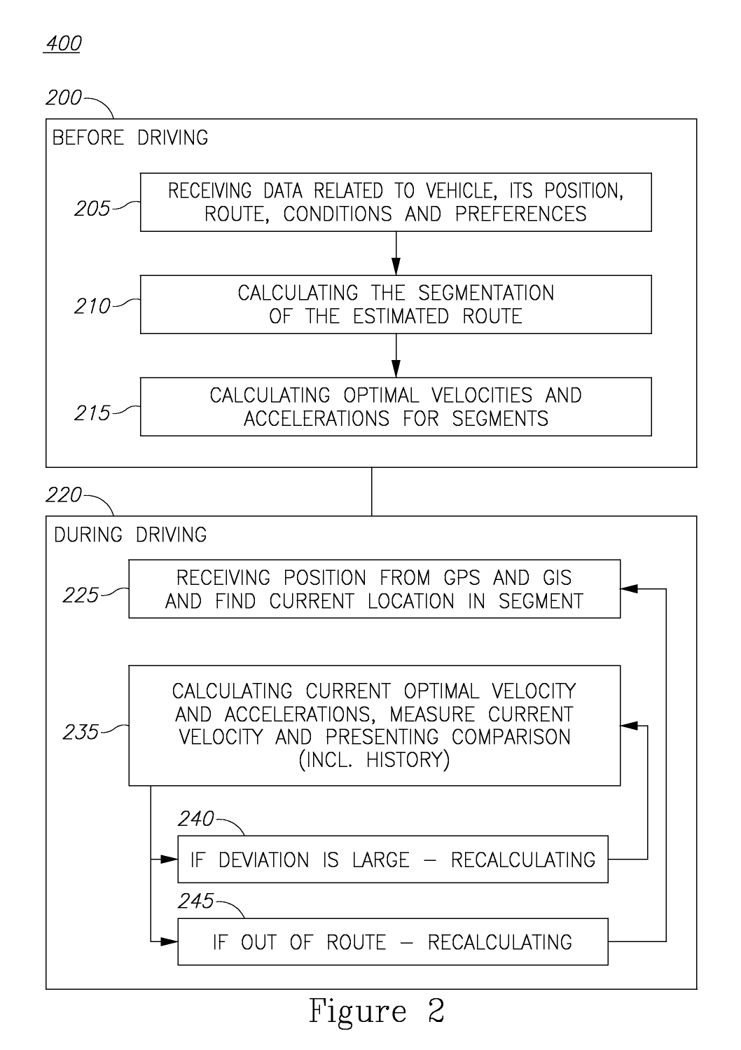

FIG. 2 is a flowchart illustrating a method 400 of suggesting a driving behavior that reduces fuel consumption to a user driving a vehicle along an estimated route, according to some embodiments of the invention. Method 400 comprises preparation phase before the actual driving (stage group 200) and a phase during the driving (stage group 220). The preparation phase 200 comprises the stages: Receiving data related to the vehicle, its position, the estimated route, environmental driving conditions along the estimated route and user preferences (stage 205), e.g. by user definition, automatically defined, from a database, from data sources in the vehicle, from external data sources etc.

Method 400 further comprises the following stages: (i) Segmenting the estimated route (stage 210) from a database on a server or from a module within the vehicle. Segmenting may be either calculated by an application or received from a source such as a digital ADAS (Advanced driver assistance system) map layer. (ii) Calculating optimal velocities and accelerations for at least one segment of the estimated route (stage 215), e.g. a segment following the current segment.

During actual driving (stage group 220), method 400 comprises: (i) Receiving the vehicle position and finding the current segment during driving (stage 225). The data may be received from within the vehicle (e.g. from a GPS receiver) and from remote servers. (ii) Calculating and suggesting the current optimal velocity and the accelerations during the driving (stage 235). Stage 235 may be accomplished utilizing the calculated optimal velocities and accelerations for at least one relevant segment (stage 215) and the vehicle position and current segment, received in stage 225.

According to some embodiments of the invention, receiving the vehicle position (stage 225) may further comprise receiving or measuring vehicle velocity, vehicle acceleration, vehicle momentum. Velocity and acceleration of the vehicle may be directly measured by an acceleration sensor or received via a communication link to a accelerometer sensor. Receiving the vehicle position (stage 225) may be carried out via a communication link to a GPS server or from a GPS sensor.

According to some embodiments of the invention, method 400 may further comprise feeding the driving behavior (such as the current and impending eco-speed, acceleration profile and choice of gear information) to the cruise control system of the vehicle.

According to some embodiments of the invention, data related to the vehicle may comprise car pre-defined configuration (e.g. weight, make, model, engine performance, center of gravity position) and car current condition (e.g. load, air-condition, condition of tires and brakes). Data related to the estimated route may vary along the route, and may comprise road parameters such as curve radiuses, slope banking (transverse gradient), surface materials, as well as traffic signs and rules such as maximal legal speed, stops, yields, roundabouts, T junction, etc. Data related to the environmental driving conditions along the estimated route may comprise environmental conditions such as topographical data and meteorological data, traffic conditions, or combinations thereof. Data related to the user preferences (e.g. a PIN or password, driver characteristics such as age, gender, former accidents, temperament and other preferences).

According to some embodiments of the invention, in cases of large deviations of the current velocity from the optimal velocity (stage 240), the optimal velocity may be recalculated (stage 235) according to road and traffic data. If the destination was entered, and the vehicle moves out of the estimated route (stage 245), the estimated route may be recalculated (stage 225) according to current position of the vehicle.

According to some embodiments of the invention, the system and method may inform the user about the current and impending eco-speed, acceleration profile and choice of gear information upon which the cruise control, adaptive cruise control and stop-and-go systems will accelerate, cruise and slow down the vehicle. According to some embodiments of the invention, the system and method may inform the vehicle computer or cruising system of the current and impending eco-speed, acceleration profile and choice of gear information. According to some embodiments of the invention, the system and method may automatically shift gears in automatic transmission systems according to current and impending eco-speed, or suggest a gear choice in manual and tiptronic transmission systems.

According to some embodiments of the invention, the system and method may suggest current and impending eco-speed information in relation to expected traffic light indications at the time of approaching a junction or several junctions (with traffic light) in row—“green wave” speed (or range of speed).

According to some embodiments of the invention, the system and method may suggest driving behavior that reduces fuel consumption in relation to previous driver behavior or former routes taken.

According to some embodiments of the invention, the system and method may suggest overtaking behavior relating to route conditions and data.

According to some embodiments of the invention, the system and method may comprise a training module for instructing the user, which may be combined with manual instruction. The system may further comprise a website with statistical data, allowing entering user characteristics and preferences, driving routes and training.

According to some embodiments of the invention, the system and method may relate to any kind of fuel used by the vehicle, comprising gasoline, kerosene, natural gas, diesel fuel as well as electricity, and combination of fuel types (e.g. in hybrid vehicles). The system and method incorporate fuel and engine type considerations in recommending current and impending eco-speed information.

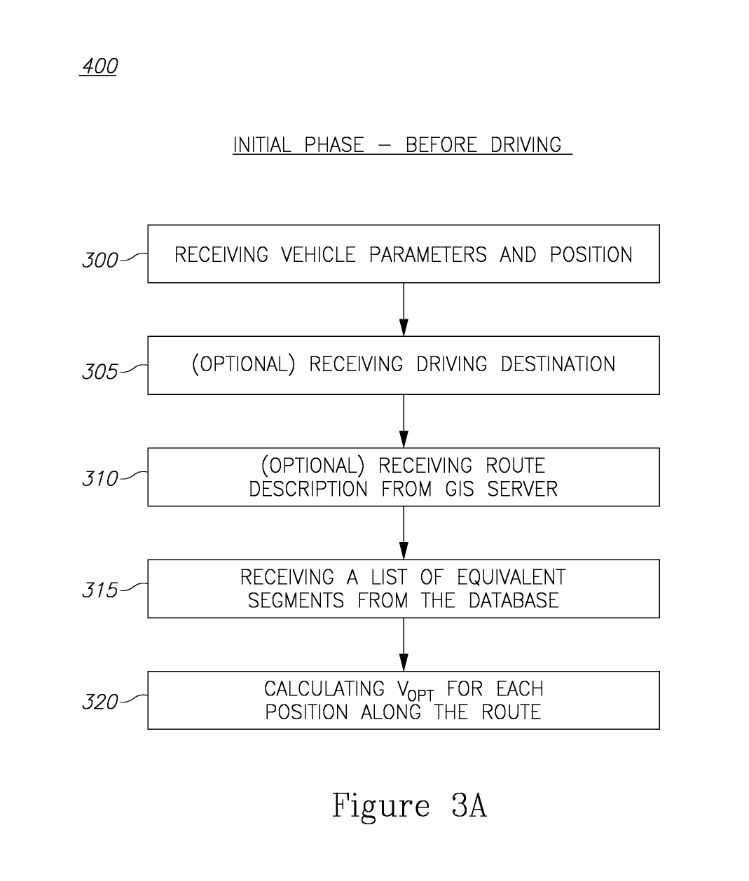

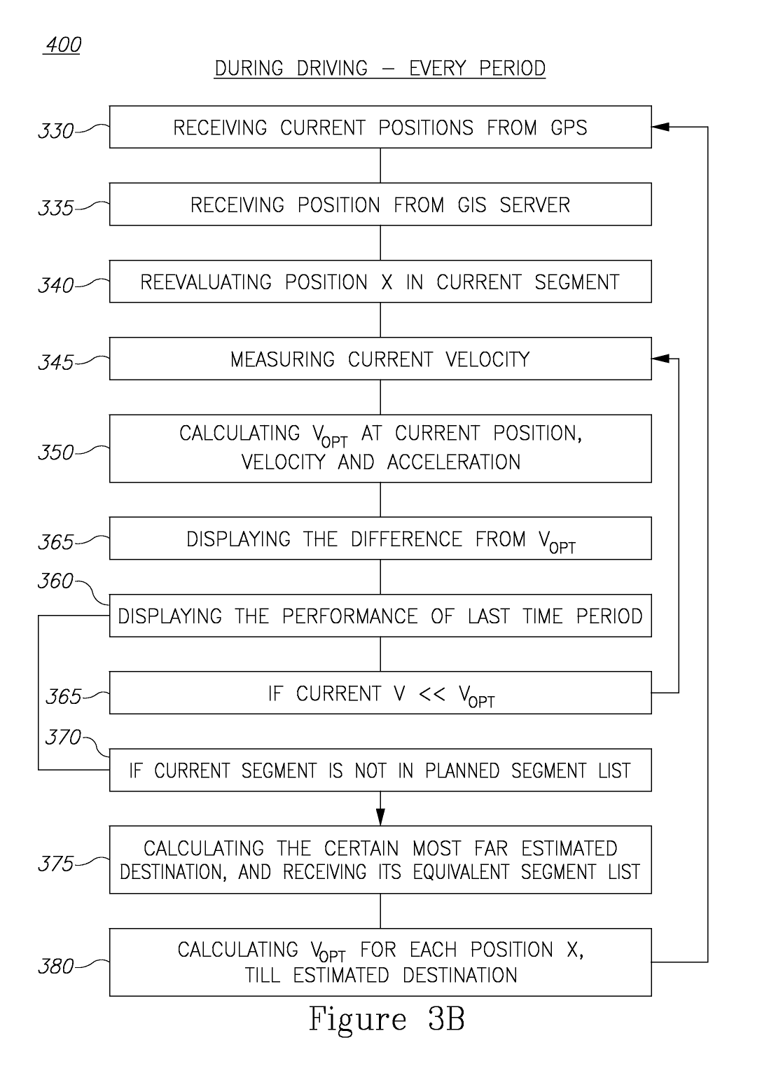

FIGS. 3A and 3B are flowcharts illustrating a method for suggesting a driving behavior that reduces fuel consumption to a user driving a vehicle along an estimated route, according to some embodiments of the invention. FIG. 3A illustrates the stages of an initial phase, performed before driving, and FIG. 3B illustrates the stages during driving, performed every predefined period.

The initial phase may comprise receiving the following information: (i) Vehicle parameters and current position (stage 300), e.g. from a GPS receiver. (ii) Driving destination (stage 305). This stage is optional, wherein the user may directly enter the destination, preprogram a destination. Method 400 may further comprise a stage of suggesting a destination (e.g. according to possible routes in relation to traffic signs, or relating to common driven routes). (iii) Route description from GIS server (stage 310). This stage is optional for cases the route is known. If not, method 400 refers to an estimated segment. (iv) A list of equivalent segments from the database (stage 315), or a near segment destination in case of no destination.

In the initial phase, method 400 further comprises calculating vₒₚₜ for each position along the segments and estimated segments of the route (stage 320).

The stages during driving comprise receiving current positions from GPS (stage 330 and/or receiving position from GIS server (stage 335).

Method 400 further comprises reevaluating each position in current segment (stage 340), measuring current velocity (stage 345), calculating vₒₚₜ at current position, velocity and acceleration (stage 350), displaying the diff from vₒₚₜ (stage 355), and displaying the performance of last time period (stage 360).

If current v<<vₒₚₜ (stage 365) return to stage 345 of measuring the current velocity.

If the current segment is not in planned segment list (stage 370), method 400 continues with calculating the certain most far estimated destination, and getting its equivalent segment list (stage 375).

Method 400 further comprises calculating vₒₚₜ for each position, till estimated destination (stage 380) and recording log for future calculations.

According to some embodiments of the invention, when the destination is unknown, the next segment is estimated according to the driving profile when approaching the end of current segment.

According to some embodiments of the invention, method 400 may be carried out locally in the vehicle, e.g. on a cell phone, or outside the vehicle, on a server.

Method 400 may be implemented as a pure software solution, on either of the following: a communication device such as a smartphone, a navigation system, a vehicle fleet managing system or a vehicle's system. Method 400 may utilize the software and hardware at the place of implementation to receive the data.

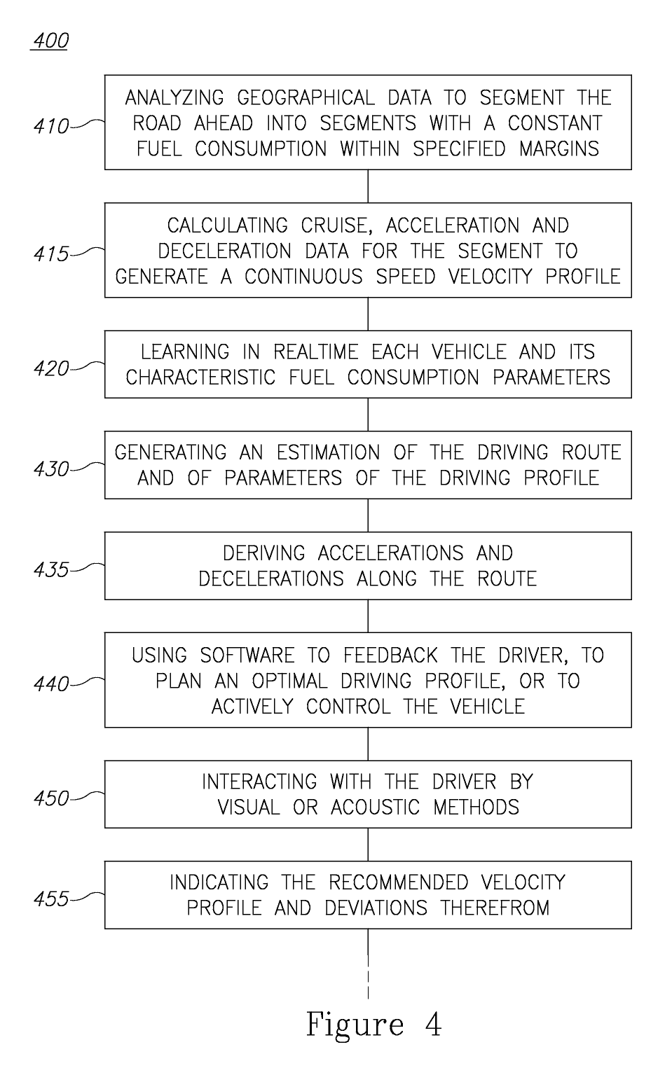

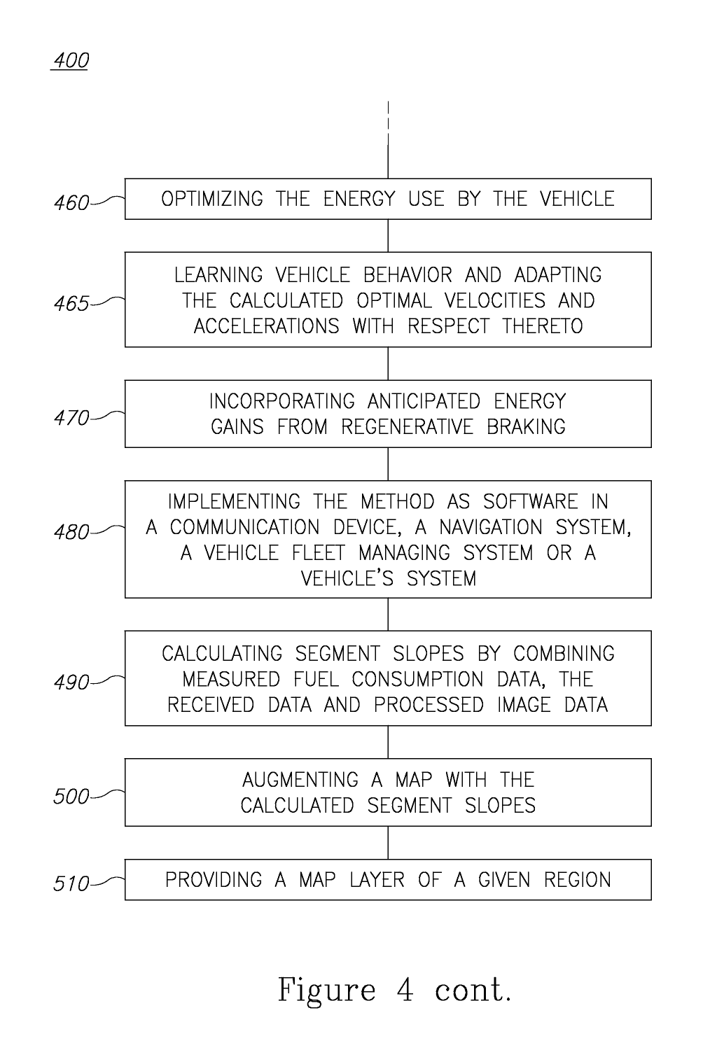

FIG. 4 is a flowchart illustrating method 400 of reducing fuel consumption by accommodating to anticipated road and driving conditions, according to some embodiments of the invention.

In embodiments, method 400 may be arranged to be implementable in association with a vehicle computer, a communication device, a vehicle fleet managing system, and a navigation system (stage 480). In particular, the invention further comprises a computer program product that comprises a computer readable storage medium having computer readable program embodied therewith. The computer readable program is configured to implement method 400 in association with any one of the above mentioned systems and devices.

The software implementing method 400 analyzes geographical data (stage 410) to segment the road ahead into segments with a constant fuel consumption (within specified margins), e.g. segments of constant slope. The software may learn in realtime each vehicle and its characteristic fuel consumption parameters (stage 420). The software may generate an estimation of the driving route and of parameters of the driving profile (e.g. velocities, accelerations and decelerations in consecutive road segments, stage 430). The software may be used either to feedback the driver, to plan an optimal driving profile respective to the present vehicle and road, or to actively control the vehicle to achieve the desired driving profile, within user specified limits (stage 440). Interaction with the driver may be carried out using any type of interface (stage 450, e.g. visual, acoustic) and interaction with other computerized system, including vehicle systems, may be carried out automatically. Overall, the software optimizes the utilization of energy by the vehicle (stage 460, e.g. may incorporate anticipated energy gain from regenerative braking into the calculations stage 470).

Method 400 may further comprise calculating cruise, acceleration and deceleration data for the segment to generate a continuous speed velocity profile (stage 415), deriving accelerations and decelerations along the route (stage 235) and indicating the recommended velocity profile and deviations therefrom (stage 455).

Method 400 may further comprise learning vehicle behavior and adapting the calculated optimal velocities and accelerations with respect thereto (stage 465).

The system and method utilize the following implementation technologies: empirical algorithms that utilize actual and realtime data, learning algorithms that derive fuel consumption parameters respective to varying road and driving conditions (including an error checking module for model verification), a systems approach, that takes into account the full driving profile over all the segments in the route, as well as the sum of energy that is used and generated in the various segments. Furthermore, the system and method use novel algorithms of calculating road parameters by combining freely accessible geographic data, satellite data, optionally driving data and a smoothing algorithm that combines the data and processes it according to the requirements of the system.

The system and method may use image processing methods to derive or correct slopes of road segments from images taken from the vehicle, from satellite imaging data, from air photos etc., and enhance the data received from other sources therewith. Furthermore, slopes can be corrected in retrospect using the fuel consumption data, and the corrected slopes may be used for future planning by the system.

The system and method combine a flexible individual treatment of each vehicle and an integrated approach that considers and compares a whole vehicle fleet to benefit from the accumulating data. Moreover, the system and method may generate better mapping data of the roads driven by the vehicles in the fleet (especially regarding slopes), and better characterization of fuel consumption to the benefit of vehicle producers and users. Additional features may include mapping of emissions (e.g. pollutants, CO₂) and mapping of noise production along the roads.

Method 400 may further comprise calculating segment slopes by combining measured fuel consumption data, the received data and processed image data (stage 490), augmenting a map with the calculated segment slopes (stage 500) and providing a map layer of a given region (stage 510), the map layer comprising the calculated segment slopes from a cumulative database of vehicles moving in the given region.

The disclosed system and methods comprise (i) an algorithm and method to learn fuel consumption of a specific given vehicle, as a function of road conditions, and then represent the knowledge within discrete building blocks and (ii) Algorithm and method, using the learned building blocks, to calculate the optimal driving profile for a given vehicle and a given route, to consume the minimal fuel amount for the route. Its main derivatives include: (i) an ability to predict amount of fuel that will be consumed by a specific vehicle driving in a specific road path, an ability to estimate road conditions (slopes) based on specific vehicle performance (fuel consumption) at that slope, and recommending driver about driving a given vehicle within a given route.

The method follows vehicle behavior over different kinds of road conditions and speed profile, then extracts the inputs and breaks them into discrete set of data. Then it filters, processes and analyzes the data, and finally, it represents the gathered knowledge within discrete tables, representing the specific vehicle fuel consumption performance.

Inputs may comprise Vehicle ECU (Electronic control unit) data (e.g. any of speed, RPM (Revolutions per minute), MAF (mass airflow sensor), torque, oxygen sensor, throttle), external inputs (e.g. any of GPS reading, accelerometer, GPRS (General packet radio service) sources, ambient temperature) and map data (e.g. any of elevations, road banks, traffic signs, junctions location and structure).

The system and methods extract from the inputs the correlation between the above listed parameters, ignore “noisy” data on the input, that was influenced by un-expected parameters and filter the noise out of the data.

Data segmenting receives continuous data samples, and maximal error limit and finds maximal times in which data variation is below the maximal error limit

The method processes accelerometer readings using a low pass filter enhance the segmenting data. The method uses map data (roads coordinates and roads elevation per each point) by using Breadth First Search algorithm, to go over all roads and junctions, for each road part, in between two junctions, get the elevation along the vehicle drive path, and convert the elevation data to slopes by derivation operation. The data is combined along the route to generate a cruise table with individual segments for the specific vehicle and drive. The segments may be compared with earlier drive data of the same vehicle and with drive data of other vehicles. The data is further used to generate acceleration and deceleration tables using road data and sensor data (e.g. MAF and throttle) for given changes in speed.

The optimal driving profile is then calculated from the cruise, acceleration and deceleration tables, given the origin and destination of the vehicle and its expected route, and the processes map data. The profile includes the points during the drive where the driver should step on throttle pedal, the pressing level of the pedal and the points where the driver should release the throttle pedal and shift to natural deceleration, so that the total fuel consumed during the drive is the minimal possible, within all possible driving profiles.

The segments are analyzed in respect to their slope, banking, curve radius, presence of junctions and speed limits, and the method anticipates the required acceleration and decelerations that would yield minimal fuel consumption. The method indicates the driver along the route where to accelerate, decelerate, and cruise, and re-calculates the above, when out of profile is detected.

In the analysis, segments are match respective to their start and end velocities, and corrected to generate a continuous velocity profile. Furthermore, accelerations and decelerations along consecutive segments are calculated to yield the calculated velocity profile.

During the drive, the method updates vehicle position and destination to recalculate segment driving data. The method may choose the next segment to be driven according to the updated data and calculate the recommended speeds. In curves, the method uses the vehicle center of gravity point, weight, curve radius, road tilt and static friction coefficient, to calculate the maximal allowed speed physically, so that the vehicle does not turn over, and does not slide aside. The calculation is based on a physical model and road data. The method and system may output the recommended speed and driver actions on a color scale, on a straight or round scale, or a combination thereof, in which each color or position indicate a different speed range or recommended action. Additionally, the system and method may indicate whether the driver is within the suggested profile and indicate its distance therefrom.

Using the segmented route and the accumulating data, the system and method may predict fuel consumption and price tag the drive. The system and method may further be used to update and correct maps with regard to the actual slopes along the driven routes and add fuel consumption layers.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of suggesting a driving behavior that reduces fuel consumption to a user with a communication device driving a vehicle along an estimated route, the method comprising:
receiving data related to the vehicle, the position of the vehicle, the estimated route, environmental driving conditions along the estimated route and user preferences;
segmenting the estimated route by constant fuel consumption or at constant slope;
calculating optimal velocities and accelerations for at least one relevant segment of the estimated route;
receiving vehicle position and finding a current segment during driving; and
calculating current fuel consumption and suggesting at least one of: optimal velocity; optimal acceleration; optimal gear and optimal gear shifting time, during driving using the calculated optimal velocities and accelerations for the at least one relevant segment following the current segment,
wherein at least one of the receiving data, the segmenting, the calculating velocities and accelerations, the receiving and finding vehicle position and the calculating and suggesting current optimal velocity and accelerations, is carried out by at least one processing unit.

2. The method of claim 1, wherein the environmental driving conditions along the estimated route comprise at least one of: topographical data, meteorological data, and traffic conditions.

3. The method of claim 1, further comprising calculating segment slopes by combining measured fuel consumption data, the received data and processed image data.

4. The method of claim 3, further comprising augmenting a map with the calculated segment slopes.

5. The method of claim 3, further comprising providing a map layer of a given region, the map layer comprising the calculated segment slopes from a cumulative database of vehicles moving in the given region.

6. The method of claim 1, further arranged to be implementable in association with at least one of: a vehicle computer, a communication device, a vehicle fleet managing system, and a navigation system.

7. The method of claim 1, wherein the segmenting is carried out to generate a continuous speed velocity profile along the route.

8. The method of claim 1, further comprising indicating the recommended driving parameters and deviations therefrom to the user.

9. The method of claim 1, further comprising learning vehicle behavior and adapting the calculated optimal velocities and accelerations with respect thereto.

10. A system comprising:
a road database comprising road data,
a vehicle database comprising vehicle data from a vehicle,
a processing unit arranged to anticipate, calculate and segment a vehicle route according to driver indications, and to derive a continuous velocity profile along the route that minimizes fuel consumption with respect to the road data and the vehicle data, and
a user interface arranged to suggest driver actions along the route according to the derived velocity profile and actual derivations of the vehicle therefrom.

11. The system of claim 10, further comprising a server having an analyzing application arranged to calculate road slopes in a given region from a cumulative database of vehicles moving in the given region.
